(19) United States
(12) Patent Application Publication
(10) Pub. No.: US 2002/0114029 A1
(43) Pub. Date: Aug. 22, 2002

(54) SRS pilot tone interaction and higher order effects in optical performance monitoring

(76) Inventors: Saeid Seydnejad, Ottawa (CA); James Harley, Ottawa (CA)

Correspondence Address: Gowling Lafleur Henderson LLP, Suite 2600, 160 Elgin Street, Ottawa, ON, K1P 1C3, CA

(21) Appl. No.: 10/013,680

(22) Filed: Dec. 13, 2001

(30) Foreign Application Priority Data
Dec. 18, 2000 (CA) 2,328,748

(51) Int. Cl. H04B 10/08; H04B 10/00

(52) U.S. Cl. 359/110; 359/161

(57) ABSTRACT

The present invention relates to higher order effects in Stimulated Raman Scattering (SRS) error estimation in an optical fiber network, the network characterized in that it comprises the infrastructure required to measure the power levels of all optical channels using a pilot tone monitoring technique, the estimation comprising the steps of determining the multi-channel SRS error value by applying small signal analysis to the solution of the SRS system of differential equations, calculating the SRS error in a single fiber span for all channels by creating a Dither Transfer Matrix (DTM) and estimating SRS by observing higher order effects within the DTM.

### FIELD OF THE INVENTION

The present invention relates to optical performance monitoring of an optical fiber network and more specifically to Stimulated Raman Scattering (SRS) error estimation and its effect on estimating the average power for each optical wavelength using the pilot tone method.

### BACKGROUND OF THE INVENTION

Today's optical fiber networks carry many channels along their optical fibers. A significant challenge in maintaining these networks is the problem of power level estimation within these channels at every point in the network or in other words optical performance monitoring. A simple tool for optical performance monitoring and channel identification in DWDM (Dense Wave Division Multiplexing) systems is to add small signal sinusoidal dithers (pilot tones) to optical carriers. Consequently, each optical carrier has a unique sinusoidal dither whose amplitude is proportional to the average power of its carrier. These pilot tones are superimposed to the average power of the optical channel and can be separated and analysed easily. The presence of a specific dither at a particular point in the network therefore indicates the presence of its corresponding wavelength and its amplitude will show the average optical power.

This is true when each dither travels solely with its optical carrier. However, an effect known as Stimulated Raman Scattering (SRS) precipitates an inter-channel energy transfer that interferes with the ability to accurately estimate power levels through pilot tones. This inter-channel energy transfer occurs from smaller wavelengths to larger wavelengths causing larger wavelength power levels to increase. SRS not only causes an interaction between the average power of each channel but also brings about a transfer of dithers between different channels. Therefore, the dither amplitude will not be proportional to the power of its carrier any more. This causes inaccuracy in power level estimation.

If the SRS becomes severe, for example by increasing the number of channels, the dither induced in other channels can be transferred backor even reverberates back and forth between different channels. We call this phenomenon higher order effects. Higher order effects bring about new phenomena such as dither phase reversal or dither cancellation explained in the following.

SRS causes inaccuracy in the power measured by pilot tones. This inaccuracy increases dramatically due to higher order effects for a system with a large number of channels and specifically when conventional (C) and extended (L) band wavelengths are present. Characterization of this inaccuracy as explained here will help us to predict and alleviate the amount of error in pilot tones power estimation.

Therefore what is need is a method of characterizing the inaccuracy in power measured by pilot tones due to SRS higher order effects.

### SUMMARY OF THE INVENTION

The present invention is directed to a method for Stimulated Raman Scattering (SRS) error estimation incorporating higher order effects in an optical fiber network, the network characterized in that it comprises the infrastructure required to measure the power levels of all optical channels using a pilot tone monitoring technique, the estimation method comprising the steps of determining the multi-channel SRS error value by applying small signal analysis to the solution of the SRS system of differential equations as given below:

$$\frac{ⅆ {p}_{n} ( z )}{ⅆ z} + α \cdot {p}_{n} ( z ) + ( \frac{{g}^{′} Δ f}{2 A} ) {p}_{n} ( z ) {\sum }_{m = 1}^{N} ( m - n ) {p}_{m} ( z ) = 0$$

where pₙ(z) is the power of the nth channel as a function of propagation distance z, a is the fiber attenuation coefficient, g′=dg/df represents the slope of the Raman gain profile, Δf is the inter-channel frequency spacing and A is the effective cross-sectional area of the (single-mode) fiber and calculating the SRS error in a single fiber span for all channels by creating a Dither Transfer Matrix (DTM) to estimate SRS error by using the DTM to incorporate higher order effects, the equation substantially equal to

$$[ \begin{matrix}Δ {p}_{1} \\ Δ {p}_{2} \\ ⋮ \\ Δ {p}_{N}\end{matrix} ] = [ \begin{matrix}{f}_{11} & {f}_{12} & ⋯ & {f}_{1 N} \\ {f}_{21} & {f}_{22} & ⋯ & {f}_{2 N} \\ ⋮ & ⋮ & & ⋮ \\ {f}_{N 1} & {f}_{N 2} & ⋯ & {f}_{NN}\end{matrix} ] [ \begin{matrix}{a}_{1} \\ {a}_{2} \\ ⋮ \\ {a}_{3}\end{matrix} ]$$

each fₖᵢ reflecting the amount of energy transfer from the dither of channel i to channel k. aᵢ denotes the dither power in channel i.

In an aspect of the invention, the method is further comprised of extending to estimate the SRS error with both a conventional (C) band detector and an extended (L) band detector of a C&L band system whereby the combined data of the two detectors is inputted into the DTM to estimate the SRS error.

Characterizing the dither interaction and higher order effects can have various applications in evaluating the performance of the optical monitoring and the accuracy of the apparatus which uses pilot tones for its calculation. This is particularly important for modern DWDM systems in which the density of channels are beyond 40. The invention relates to unidirectional systems.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

These and other features, aspects, and advantages of the present invention will become better understood with regard to the following description, appended claims, and accompanying drawings where:

FIG. 1 is a flow chart showing method for Stimulated Raman Scattering (SRS) error estimation incorporating higher order effects in an optical fiber network;

FIG. 2 is a flow chart showing method for Stimulated Raman Scattering (SRS) error estimation incorporating higher order effects in an optical fiber network further comprising extending to estimate the SRS error with both a conventional (C) band detector and an extended (L) band detector of a C&L band system whereby the combined data of the two detectors is inputted into the DTM to estimate the SRS error;

FIG. 3 is a flow chart showing system for Stimulated Raman Scattering (SRS) error estimation incorporating higher order effects in an optical fiber network;

FIG. 4 is a flow chart showing system for Stimulated Raman Scattering (SRS) error estimation incorporating higher order effects in an optical fiber network further comprising a fourth network component having embedded computer readable code for extending to estimate the SRS error with both a conventional (C) band detector and an extended (L) band detector of a C&L band system whereby the combined data of the two detectors is inputted into the DTM to estimate the SRS error;

FIG. 5 is a graph displaying A, B and A-B for an 80-channel single span (80 km) NDSF system, with 6 dBm launch power when channel 12 is excited with a sinusoidal dither;

FIG. 6 is a graph showing when a positive phase dither (1% modulation) is given to channel 10, in a 20-channel single span system a positive phase dither is induced in channel 12 but a negative phase dither in channel 8;

FIG. 7 is a graph showing when a positive phase dither (1% modulation) is given to channel 10, in a 20-channel single span system a positive phase dither is induced in channel 12 but a negative phase dither in channel 8;

FIG. 8 is a graph showing that if SRS becomes more severe by increasing the number of channels from 20 to 30 the induced dither at channel 12 will start decreasing;

FIG. 9 is a graph showing that if SRS becomes more severe by increasing the number of channels from 20 to 30 the induced dither at channel 12 will start decreasing;

FIG. 10 is a graph showing that for 60 channels the phase in channel 12 is completely reversed;

FIG. 11 is a graph showing that for 60 channels the phase in channel 12 is completely reversed;

FIG. 12 is a graph showing the SRS transfer function for the C detector behaving like a notch filter; and

FIG. 13 is a graph showing the SRS error for average power in the same system.

### DETAILED DESCRIPTION OF THE PRESENTLY PREFERRED EMBODIMENT

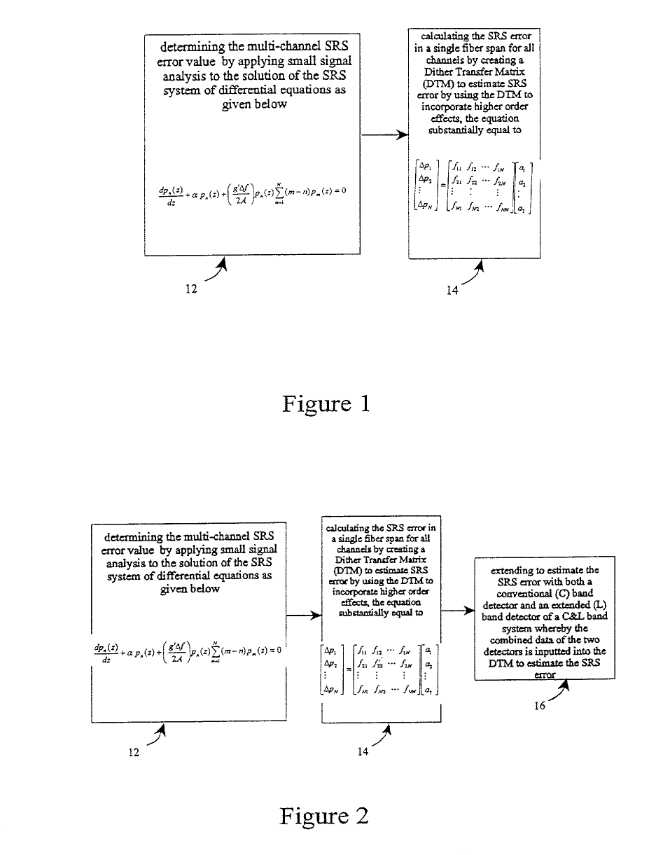

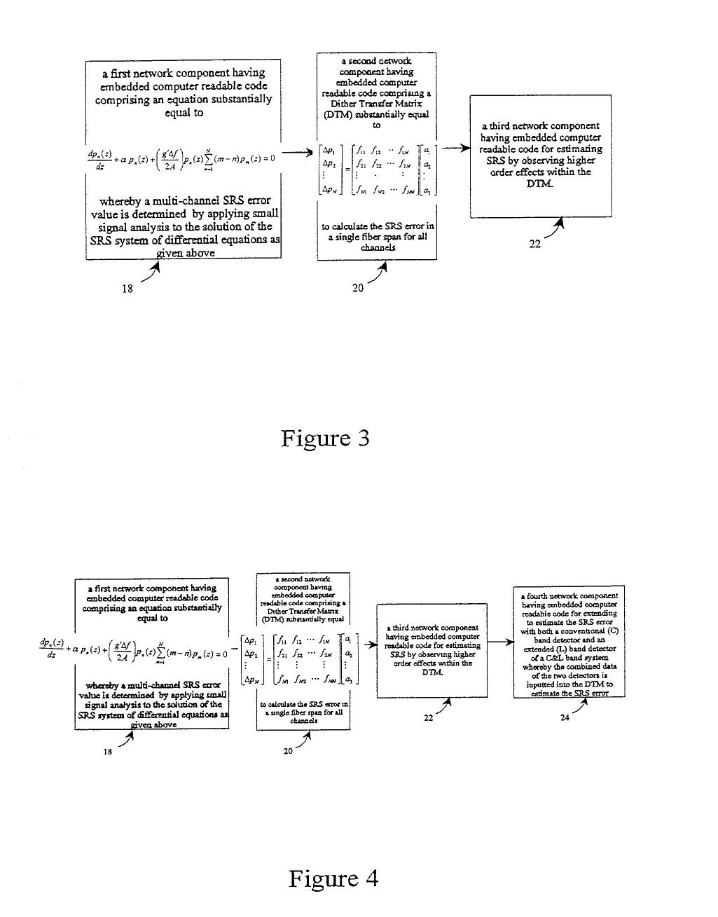

As shown in FIG. 1, an embodiment of the method for Stimulated Raman Scattering (SRS) error estimation incorporating higher order effects in an optical fiber network, the network characterized in that it comprises the infrastructure required to measure the power levels of all optical channels using a pilot tone monitoring technique, the estimation method comprises the steps of determining the multi-channel SRS error value by applying small signal analysis to the solution of the SRS system of differential equations as given below

$$\frac{ⅆ {p}_{n} ( z )}{ⅆ z} + α \cdot {p}_{n} ( z ) + ( \frac{{g}^{′} Δ f}{2 A} ) {p}_{n} ( z ) {\sum }_{m = 1}^{N} ( m - n ) {p}_{m} ( z ) = 0$$

where pₙ(z) is the power of the nth channel as a function of propagation distance z, a is the fiber attenuation coefficient, g′=dg/df represents the slope of the Raman gain profile, Δf is the inter-channel frequency spacing and A is the effective cross-sectional area of the (single-mode) fiber 12 and calculating the SRS error in a single fiber span for all channels by creating a Dither Transfer Matrix (DTM) to estimate SRS error by using the DTM to incorporate higher order effects, the equation substantially equal to

$$[ \begin{matrix}Δ {p}_{1} \\ Δ {p}_{2} \\ ⋮ \\ Δ {p}_{N}\end{matrix} ] = [ \begin{matrix}{f}_{11} & {f}_{12} & ⋯ & {f}_{1 N} \\ {f}_{21} & {f}_{22} & ⋯ & {f}_{2 N} \\ ⋮ & ⋮ & & ⋮ \\ {f}_{N 1} & {f}_{N 2} & ⋯ & {f}_{NN}\end{matrix} ] [ \begin{matrix}{a}_{1} \\ {a}_{2} \\ ⋮ \\ {a}_{3}\end{matrix} ]$$

each fₖᵢ reflecting the amount of energy transfer from the dither of channel i to channel k. a₁ denotes the dither power in channel i 14.

As shown in FIG. 2, in an embodiment of the invention, the method is further comprised of extending to estimate the SRS error with both a conventional (C) band detector and an extended (L) band detector of a C&L band system whereby the combined data of the two detectors is inputted into the DTM to estimate the SRS error 16.

Introduction

A detailed analysis of dither interaction and higher order effects on pilot tones due to SRS is presented. By applying the small signal analysis to the analytic solution of the SRS equation the concept of Dither Transfer Matrix (DTM) is introduced. DTM provides a rigorous tool for studying the SRS dither interaction and the estimation of error in pilot tone optical performance monitoring of DWDM systems. By using the DTM it will be shown that when SRS becomes severe, by increasing the number of channels or launch power, new pitfalls like phase reversal phenomenon or dither cancellation will appear. This consideration is of particular importance when extended band (L-band) is in service in addition to the conventional band (C-band) in a DWDM system.

SRS Dither Interaction and Dither Transfer Matrix

For average power SRS causes energy transfer from shorter wavelengths to longer ones. In other words SRS for average power is a unidirectional phenomenon. In, dither domain one would expect to see the same effect; a sinusoidal change in shorter wavelengths should induce the same pattern in the longer wavelengths. However, the energy transfer in the dither domain is more complex. Recalling that in power estimation using pilot tones the proportionality between the average power of the wavelength and the amplitude of its dither is important.

To analyse the SRS energy transfer in dither domain we should analyse the SRS governing equation in a small signal manner as follows. The evolution of SRS power exchange between channels is governed by the following set of ordinary differential equations [1]:

$$\frac{ⅆ {p}_{n} ( z )}{ⅆ z} + α \cdot {p}_{n} ( z ) + ( \frac{{g}^{′} Δ f}{2 A} ) {p}_{n} ( z ) {\sum }_{m = 1}^{N} ( m - n ) {p}_{m} ( z ) = 0 \qquad ( 1 )$$

In (1)pₙ(z) is the power of the nth channel as a function of propagation distance z, a is the fiber attenuation coefficient, g′=dg/df represents the slope of the Raman gain profile, Δf is the inter-channel frequency spacing and A is the effective cross-sectional area of the (single-mode) fiber. It has been shown that the nonlinear system of equations (1), exhibits the following general solution [1]:

$$\begin{matrix}{p}_{n} ( z ) = {p}_{n 0} {J}_{0} {ⅇ}^{- α z} {exp [ {GJ}_{0} ( n - 1 ) {Z}_{e} ] [ {\sum }_{m = 1}^{N} {p}_{m 0} exp ( {GJ}_{0} ( m - 1 ) {Z}_{e} ) ]}^{- 1} \\ where , & ( 2 ) \\ G = \frac{{g}^{′} Δ f}{2 A} & ( 3 ) \\ {J}_{0} = {\sum }_{m = 1}^{N} {p}_{m 0} & ( 4 ) \\ {Z}_{e} = \frac{1 - {ⅇ}^{- α z}}{α} & ( 5 )\end{matrix}$$

pₙ₀ in the above equations denotes the nth channel input power. It is important to note that equation (2) is still applicable even under conditions of significant pump depletion as well as in the case of unequal channel loading.

Since in pilot tone power estimation small sinusoidal dithers are superimposed to the optical power of each channel we have to analyse the small signal behavior of equation (2). If for the kth channel we define

fₖ(p₁₀, p₂₀, . . . , pₖ₀, . . . , p_{N0})=pₖ(z) (6)

then with the first order approximation we will have,

$$Δ {p}_{k} ( z ) = {\sum }_{i = 1}^{N} \frac{δ \cdot {f}_{k}}{δ \cdot {p}_{i 0}} Δ {p}_{i 0} \qquad ( 7 )$$

If Δpᵢ₀ is a function of t then,

$$Δ {p}_{k} ( z , t ) = {\sum }_{i = 1}^{N} {f}_{ik}^{′} Δ {p}_{i 0} ( t ) \qquad ( 8 )$$

Assuming Δpᵢ₀(t)=aᵢ sin(wᵢt +θᵢ) yields,

$$Δ {p}_{k} ( z , t ) = {\sum }_{i = 1}^{N} {f}_{ki} {a}_{i} sin ( {w}_{i} t + {θ}_{i} ) \\ k = 1 , 2 , … , N \qquad ( 9 )$$

in which aᵢ denotes the amplitude of the dither at the input of the fiber. Equation (9) reveals that the dither power for channel k is the summation of all sinusoids with the scaling factor given by fₖᵢ^{′}aᵢ. By applying derivative to equation (2) we can obtain

$${f}_{ki} = \{ \begin{matrix}\frac{lv + {l}^{′} uv - {ulv}^{′}}{{v}^{2}} {p}_{k 0} {ⅇ}^{- α z} , & i \neq k & ( a ) \\ ( \frac{ul}{v} + \frac{lv + {l}^{′} uv - {ulv}^{′}}{{v}^{2}} {p}_{k 0} ) {ⅇ}^{- α z} , & i = k & ( b )\end{matrix} \qquad ( 10 )$$

in which

u=J₀ (11)

l=exp(G(k−1)ZₑJ₀) (12)

l′=G(k−1)Zₑexp(G(k−1)ZₑJ₀) (13)

$$\begin{matrix}v = {\sum }_{m = 1}^{N} {p}_{m 0} {e}^{G ( m - 1 ) {Z}_{e} {J}_{0}} & ( 14 ) \\ {v}^{′} = {e}^{G ( i - 1 ) {Z}_{e} {J}_{0}} + {\sum }_{m = 1}^{N} {p}_{m 0} G ( m - 1 ) {Z}_{e} {e}^{G ( m - 1 ) {Z}_{e} {J}_{0}} & ( 15 )\end{matrix}$$

Equation (9) can be written as:

$$[ \begin{matrix}Δ {p}_{1} \\ Δ {p}_{2} \\ ⋮ \\ Δ {p}_{N}\end{matrix} ] = [ \begin{matrix}{f}_{11} & {f}_{12} & ⋯ & {f}_{1 N} \\ {f}_{21} & {f}_{22} & ⋯ & {f}_{2 N} \\ ⋮ & ⋮ & & ⋮ \\ {f}_{N 1} & {f}_{N 2} & ⋯ & {f}_{NN}\end{matrix} ] [ \begin{matrix}{a}_{1} \\ {a}_{2} \\ ⋮ \\ {a}_{N}\end{matrix} ] \qquad ( 16 )$$

The N×N matrix in fact shows the dither interaction between different channels. Each fₖᵢ reflects the amount of energy transfer from the dither of channel i to channel k. Note that aᵢ denotes the dither power in channel i. Let us call the N×N matrix the Dither Transfer Matrix (DTM).

If there is no SRS, by disregarding the fiber loss (e^{-az}), DTM will become an identity matrix. In this case each dither will be proportional to its corresponding average power. In the presence of SRS this proportionality will not be valid anymore. Consequently, pilot tone optical performance monitoring will not be accurate in the presence of SRS. DTM as derived above will give us a toot to estimate the SRS impact on dither amplitudes and thereby provides us amethod to compensate for this inaccuracy.

In general

$${\sum }_{k = 1}^{N} {f}_{ki} = 1$$

in DTM because the total amount of dither over all channels at every point.

Phase Reversal phenomenon

If one channel is excited with a sinusoidal dither, longer wavelengths will display the same dither with the same phase whereas shorter wavelengths illustrate the same dither but with negative phase. Even more, depending on the severity of SRS some of the longer wavelengths might also show the induced dither but with a negative phase. This phase reversal phenomenon on longer wavelengths is due to higher order effects and appears at the adjacent longer wavelengths to the excited channel. DTM can now help us to characterize the phase reversal phenomenon.

When SRS is not severe fₖᵢ>0 for i<k ands fₖᵢ<0 for i>k In order to characterize the higher order effects and phase reversal phenomenon we should consider the case where fₖᵢ<0 for i<k. In other words, lv+l′uv−ulv′<0 for i<k.

$$lv + {l}^{′} uv - {ulv}^{′} < 0 ⇒ lv + \frac{G ( k - 1 )}{α} luv - {ulv}^{′} < 0 ⇒ v + \frac{G ( k - 1 )}{α} uv - {uv}^{′} < 0 \qquad ( 17 )$$

Since u>0 and v>0 we should compare

$$v + \frac{G ( k - 1 )}{α} uv$$

against uv′.

If:

$$\begin{matrix}A {=}^{Δ} v + \frac{G ( k - 1 )}{α} uv = v + \frac{G ( k - 1 )}{α} {j}_{0} v \\ and & ( 18 ) \\ B {=}^{Δ} {uv}^{′} = {j}_{0} ( {e}^{G ( i - 1 ) {j}_{0} / α} + {\sum }_{m = 1}^{N} {p}_{m 0} \frac{G ( m - 1 )}{α} {e}^{G ( m - 1 ) {j}_{0} / α} ) & ( 19 )\end{matrix}$$

we obtain:

$$\begin{matrix}A = v + v \frac{G ( k - 1 )}{α} {j}_{0} & ( 20 ) \\ B = {j}_{0} R + {j}_{0} {e}^{G ( i - 1 ) {j}_{0} / α} where \\ R {=}^{Δ} {\sum }_{m = 1}^{N} {p}_{m 0} \frac{G ( m - 1 )}{α} {e}^{G ( m - 1 ) {j}_{0} / α} & ( 21 )\end{matrix}$$

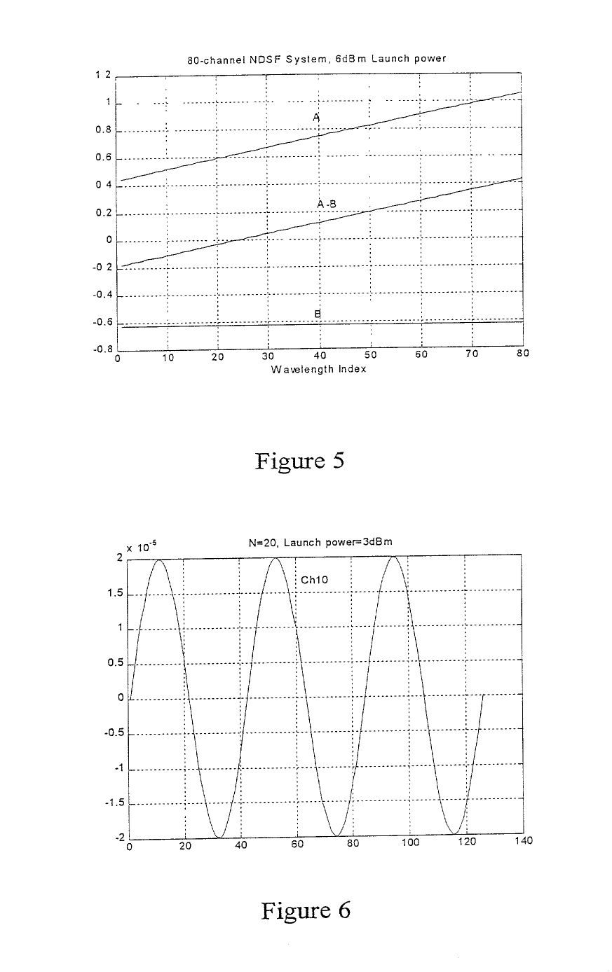

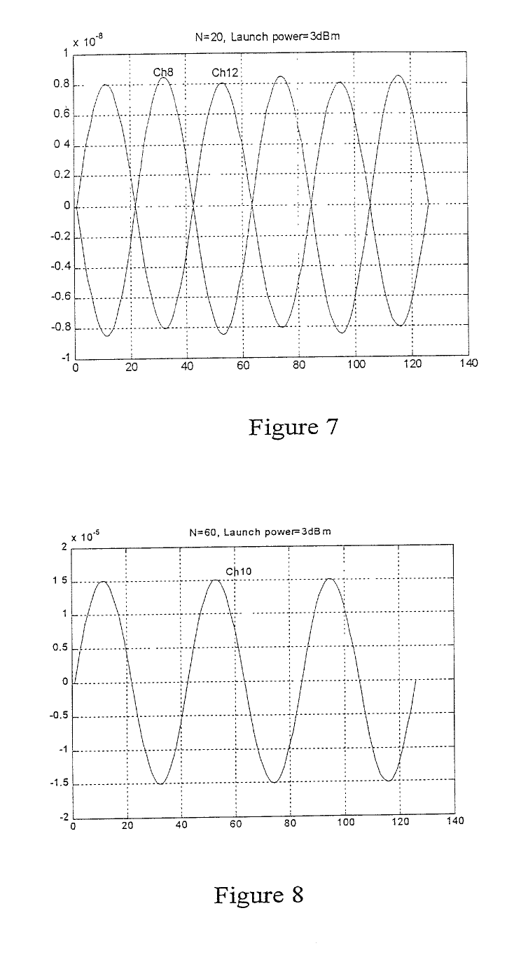

In order to observe the higher order effects we should have B>A. Since R and v are constants the balance between A and B will depend on the values of i and k. The values of R and v on other hand depend on the number of channels and the launch power. More number of channels and more input power will give more weight to j₀R compared to v causing the higher order effects to become more prominent. FIG. 5 displays A, B and A-B for an 80-channel single span (80 km) NDSF system, with 6 dBm launch power when channel 12 is excited with a sinusoidal dither. Phase reversal can be observed up to channel 24 in this case.

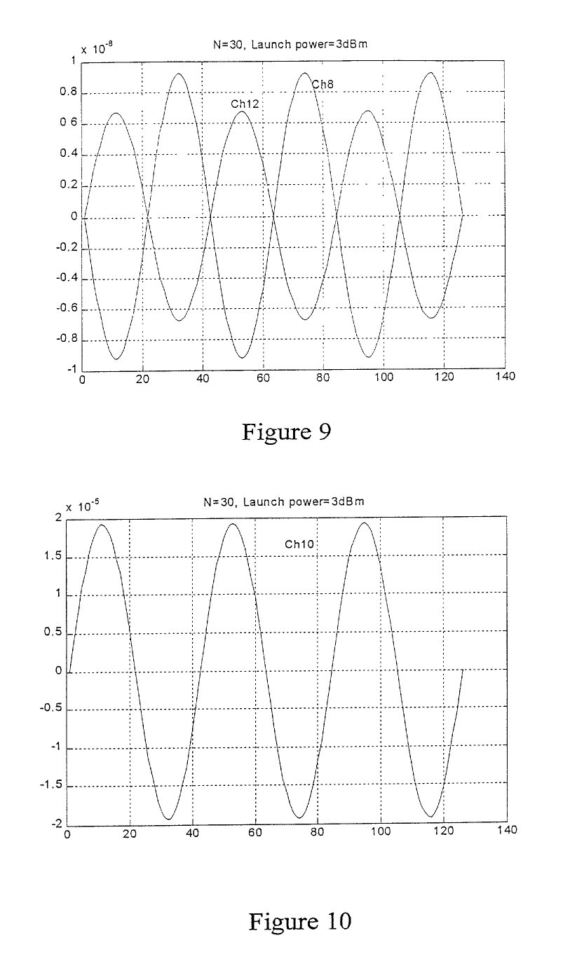

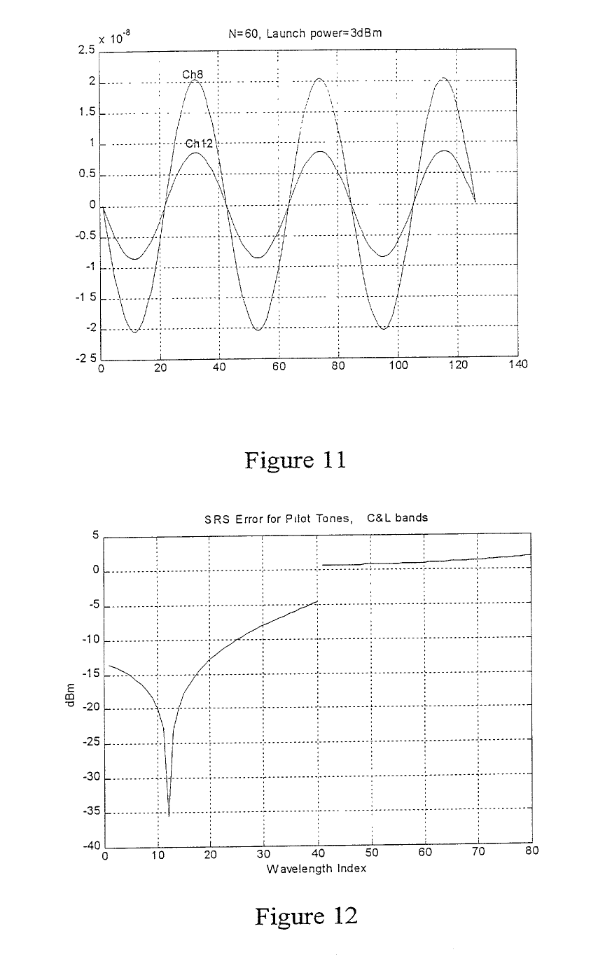

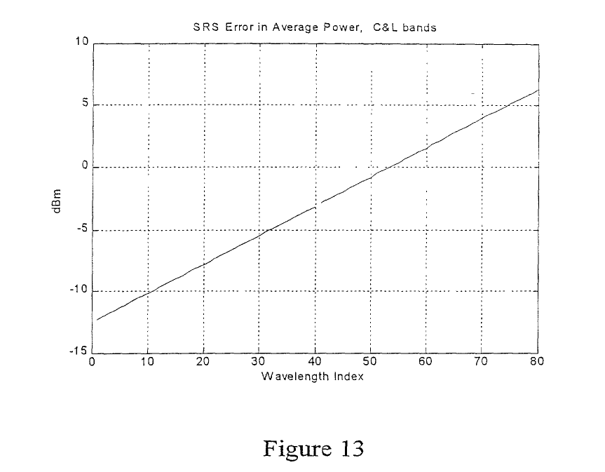

Higher order effects appear when the system encounters severe SRS effect. To observe the higher order effects we gradually increase the severity of SRS by adding more wavelengths into the system. FIGS. 6 (dither in channel 10, DC power has been removed for better presentation) and 7 (the induced dither in channels 8 and 12 (W), DC power has been removed for better presentation) show when a positive phase dither (1% modulation) is given to channel 10, in a 20-channel single span system a positive phase dither is induced in channel 12 but a negative phase dither in channel 8. If SRS becomes more severe by increasing the number of channels from 20 to 30 the induced dither at channel 12 will start decreasing as shown in FIGS. 8 and 9. For 60 channels the phase in channel 12 is completely reversed as shown in FIGS. 10 and 11. Phase reversal becomes more obvious when the system is under heavy SRS effect.

Dither Cancellation

Phase reversal is not the only outcome of severe SRS influence in dither domain. When positive phase dithers are induced in some channels but negative phase dithers in others it will be very likely to have a zero resultant when a certain number of channels are considered. This case for example can happen in C+L bands where different detectors are allocated to different bands. In this situation the resultant dither, detected by the C-band detector, might become (almost) zero.

As a typical example let's assume an 80-channel C+L band system when (only) channel M (for simplicity) in the C band is excited with a dither at a certain frequency. Now if the system is under a heavy SRS effect some of the channels with larger wavelengths than M (say (M+1) to (M+10)) show the dither with negative phase (phase reversal phenomenon) instead of positive.

The detector in the apparatus which monitors the optical power normally looks at the C band only and picks up the first 40 channels. All channels 1 to M−1 and (M+1) to (M+10) have dither with negative phase while channels (M+11) to 40 and also M have 15 dither with positive phase. Summation of all these dithers by the detector at the first 40 channels might cause cancellation of negative and positive dithers at this band. In other words although the total summation of dithers over C and L bands together is still one (conservation of energy), for the C detector only the summation would be zero. This causes a severe error in pilot tone power estimation (in reality the resultant dither may not be exactly zero but very close to zero).

In fact in this case the SRS transfer function for the C detector behaves like a notch filter. This phenomenon is pictured in FIG. 12 for a 6-span 80 channels C+L (C=40, L=40, C-L gap=10 channels) NDSF system with 2 dBm launch power. As it can be seen channels 11-13 illustrate dither cancellation. For this simulation equation (2) was employed and 1% sinusoidal dither was added to each channel separately. Then the total dither for each individual channel over the C band (first 40 channel) or L band (second 40 channel) was calculated. For example if the channel was located in the C band it was first excited with a sinusoidal dither. Then at the last span all induced dithers in the C band were added together. If the channel was located in the L band then summation was performed only over the L band channels.

FIG. 9 displays the SRS error for average power in the same system. Since energy transfer for average power is unidirectional the familiar SRS tilt shows up.

Comparing FIGS. 12 with 13 reveals that the SRS energy transfer for pilot tones is completely different with average optical power. Since the dithers should convey the information of the average power the results produced by pilot tones will be inaccurate. Using the DTM and estimating the dither amplitude now provides a means to compensate for this inaccuracy. To do so it is sufficient to subtract the SRS impact on average power from the SRS impact on pilot tones and compensate in the opposite direction.

In order to formulate the dither cancellation we should consider

$${\sum }_{k = 1}^{Q} {f}_{ki} = 0$$

in the DTM matrix where Q is detector wavelength range (40 in our case). If,

$$C {=}^{Δ} {{\sum }_{k = 1}^{Q}}_{Q > i} {f}_{ki} = {{{\sum }_{k = 1}^{Q}}_{Q > i}}_{k \neq i} \frac{lv + {l}^{′} uv - {ulv}^{′}}{{v}^{2}} {p}_{k 0} {e}^{- α z} + {{{\sum }_{k = 1}^{Q}}_{Q > i}}_{k \neq i} ( \frac{ul}{v} + \frac{lv + {l}^{′} uv - {ulv}^{′}}{{v}^{2}} {p}_{k 0} ) {e}^{- α z} = {{\sum }_{k = 1}^{Q}}_{Q > i} \frac{( lv + {l}^{′} uv - {ulv}^{′} ) {p}_{k 0} + ulv δ ( k - i )}{{v}^{2}} = 0 \qquad ( 23 )$$

where δ(k−i) is the unit sample function.

Therefore, phase cancellation happens when C1=0 and

$$C 1 {=}^{Δ} {{\sum }_{k = 1}^{i}}_{Q > i} l ( v + \frac{G ( k - 1 )}{α} {j}_{0} - {v}^{′} {j}_{0} ) {p}_{k 0} + {j}_{0} vl δ ( k - i ) \qquad ( 24 )$$

Conclusion

Pilot tones provide a simple yet reliable method for measuring the average optical power for each wavelength in a DWDM system. The accuracy of pilot tone power estimation however depends on the severity of SRS in the system. The dither transfer matrix as derived here gives us a perfect means to analyze the effect of SRS on pilot tones and the way they interact which other. Consequently, compensation for the error in pilot tone power measurement would be possible by using the DTM. Particularly, DTM can predict the phenomena like higher order effects and dither cancellation.

Characterizing the higher order effects can have various applications in evaluating the performance of optical monitoring features, particularly when the number of channels rises above 40.

Although the present invention has been described in considerable detail with reference to certain preferred versions thereof, other versions are possible. Therefore, the spirit and scope of the appended claims should not be limited to the description of the preferred versions contained herein.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method for Stimulated Raman Scattering (SKS) error estimation incorporating higher order effects in an optical fiber network, the network characterized in that it comprises the infrastructure required to measure the power levels of all optical channels using a pilot tone monitoring technique, the estimation method comprising the steps of
(i) determining the multi-channel SRS error value by applying small signal analysis to the solution of the SRS system of differential equations as given below:
$$\frac{ⅆ {p}_{n} ( z )}{ⅆ z} + α \cdot {p}_{n} ( z ) + ( \frac{{g}^{′} Δ f}{2 A} ) {p}_{n} ( z ) {\sum }_{m = 1}^{N} ( m - n ) {p}_{m} ( z ) = 0$$
where pₙ(z) is the power of the nth channel as a function of propagation distanced, t is the fiber attenuation coefficient, g′=dg/df represents the slope of the Raman gain profile, Δf is the inter-channel frequency spacing and A is the effective cross-sectional area of the (single-mode) fiber; and
(ii) calculating the SRS error in a single fiber span for all channels by creating a Dither Transfer Matrix (DTM) to estimate SRS error by using the DTM to incorporate higher order effects, the equation substantially equal to:
$$[ \begin{matrix}Δ {p}_{1} \\ Δ {p}_{2} \\ ⋮ \\ Δ {p}_{N}\end{matrix} ] = [ \begin{matrix}{f}_{11} & {f}_{12} & ⋯ & {f}_{1 N} \\ {f}_{21} & {f}_{22} & ⋯ & {f}_{2 N} \\ ⋮ & ⋮ & ⋮ & ⋮ \\ {f}_{N 1} & {f}_{N 2} & ⋯ & {f}_{NN}\end{matrix} ] [ \begin{matrix}{a}_{1} \\ {a}_{2} \\ ⋮ \\ {a}_{3}\end{matrix} ]$$
each fₖᵢ reflecting the amount of energy transfer from the dither of channel i to channel k. aᵢ denotes the dither power in channel i.

2. The estimation method according to claim 1, further comprised of extending to estimate the SRS error with both a conventional (C) band detector and an extended (L) band detector of a C&L band system whereby the combined data of the two detectors is inputted into the DTM to estimate the SRS error.

3. A system for Stimulated Raman Scattering (SRS) error estimation incorporating higher order effects in an optical fiber network, the network characterized in that it comprises the infrastructure required to measure the power levels of all optical channels using a pilot tone monitoring technique, the system comprising:
means for determining the multi-channel SRS error value by applying small signal analysis to the solution of the SRS system of differential equations as given below:
$$\frac{ⅆ {p}_{n} ( z )}{ⅆ z} + α \cdot {p}_{n} ( z ) + ( \frac{{g}^{′} Δ f}{2 A} ) {p}_{n} ( z ) {\sum }_{m = 1}^{N} ( m - n ) {p}_{m} ( z ) = 0$$
where pₙ(z) is the power of the nth channel as a function of propagation distanced, a is the fiber attenuation coefficient, g′=dg/df represents the slope of the Raman gain profile, Δf is the inter-channel frequency spacing and A is the effective cross-sectional area of the (single-mode) fiber; and
means for calculating the SRS error in a single fiber span for all channels by creating a Dither Transfer Matrix (DTM) to estimate SRS error by using the DTM to incorporate higher order effects, the equation substantially equal to:
$$[ \begin{matrix}Δ {p}_{1} \\ Δ {p}_{2} \\ ⋮ \\ Δ {p}_{N}\end{matrix} ] = [ \begin{matrix}{f}_{11} & {f}_{12} & ⋯ & {f}_{1 N} \\ {f}_{21} & {f}_{22} & ⋯ & {f}_{2 N} \\ ⋮ & ⋮ & ⋮ & ⋮ \\ {f}_{N 1} & {f}_{N 2} & ⋯ & {f}_{NN}\end{matrix} ] [ \begin{matrix}{a}_{1} \\ {a}_{2} \\ ⋮ \\ {a}_{3}\end{matrix} ]$$
each fₖᵢ reflecting the amount of energy transfer from the dither of channel i to channel k. aᵢ denotes the dither power in channel i.

4. The system according to claim 3, further comprised of a means for extending to estimate the SRS error with both a conventional (C) band detector and an extended (L) band detector of a C&L band system whereby the combined data of the two detectors is inputted into the DTM to estimate the SRS error.

5. A system for Stimulated Raman Scattering (SRS) error estimation incorporating higher order effects in an optical fiber network, the network characterized in that it comprises the infrastructure required to measure the power levels of all optical channels using a pilot tone monitoring technique, the system comprising:
a first network component having embedded computer readable code comprising an equation substantially equal to:
$$\frac{ⅆ {p}_{n} ( z )}{ⅆ z} + α \cdot {p}_{n} ( z ) + ( \frac{{g}^{′} Δ f}{2 A} ) {p}_{n} ( z ) {\sum }_{m = 1}^{N} ( m - n ) {p}_{m} ( z ) = 0$$
where pₙ(z) is the power of the nth channel as a function of propagation distanced, a is the fiber attenuation coefficient, g′=dg/df represents the slope of the Raman gain profile, Δf is the inter-channel frequency spacing and A is the effective cross-sectional area of the (single-mode) fiber whereby a multi-channel SRS error value is determined by applying small signal analysis to the solution of the SRS system of differential equations as given above;
a second network component having embedded computer readable code comprising a Dither Transfer Matrix (DTM) substantially equal to
$$[ \begin{matrix}Δ {p}_{1} \\ Δ {p}_{2} \\ ⋮ \\ Δ {p}_{N}\end{matrix} ] = [ \begin{matrix}{f}_{11} & {f}_{12} & ⋯ & {f}_{1 N} \\ {f}_{21} & {f}_{22} & ⋯ & {f}_{2 N} \\ ⋮ & ⋮ & ⋮ & ⋮ \\ {f}_{N 1} & {f}_{N 2} & ⋯ & {f}_{NN}\end{matrix} ] [ \begin{matrix}{a}_{1} \\ {a}_{2} \\ ⋮ \\ {a}_{3}\end{matrix} ]$$
each fₖᵢ reflecting the amount of energy transfer from the dither of channel I to channel k. aᵢ denotes the dither power in channel i, to calculate the SRS error in a single fiber span for all channels; and
a third network component having embedded computer readable code for estimating SRS by observing higher order effects within the DTM.

6. The system according to claim 5, further comprising a fourth network component having embedded computer readable code for extending to estimate the SRS error with both a conventional (C) band detector and an extended (L) band detector of a C&L band system whereby the combined data of the two detectors is inputted into the DTM to estimate the SRS error.

7. A system for Stimulated Raman Scattering (SRS) error estimation incorporating higher order effects in an optical fiber network, the network characterized in that it comprises the infrastructure required to measure the power levels of all optical channels using a pilot tone monitoring technique, the system comprising:
a network component having embedded computer readable code comprising an equation substantially equal to:
$$\frac{ⅆ {p}_{n} ( z )}{ⅆ z} + α \cdot {p}_{n} ( z ) + ( \frac{{g}^{′} Δ f}{2 A} ) {p}_{n} ( z ) {\sum }_{m = 1}^{N} ( m - n ) {p}_{m} ( z ) = 0$$
where pₙ(z) is the power of the nth channel as a function of propagation distanced, a is the fiber attenuation coefficient, g′=dg/df represents the slope of the Raman gain profile, Δf is the inter-channel frequency spacing and A is the effective cross-sectional area of the (single-mode) fiber whereby a multi-channel SRS error value is determined by applying small signal analysis to the solution of the SRS system of differential equations as given above;
the network component having embedded computer readable code comprising a Dither Transfer Matrix (DTM) equation substantially equal to
$$[ \begin{matrix}Δ {p}_{1} \\ Δ {p}_{2} \\ ⋮ \\ Δ {p}_{N}\end{matrix} ] = [ \begin{matrix}{f}_{11} & {f}_{12} & ⋯ & {f}_{1 N} \\ {f}_{21} & {f}_{22} & ⋯ & {f}_{2 N} \\ ⋮ & ⋮ & ⋮ & ⋮ \\ {f}_{N 1} & {f}_{N 2} & ⋯ & {f}_{NN}\end{matrix} ] [ \begin{matrix}{a}_{1} \\ {a}_{2} \\ ⋮ \\ {a}_{3}\end{matrix} ]$$
each fₖᵢ reflecting the amount of energy transfer from the dither of channel i to channel k. aᵢ denotes the dither power in channel i, to calculate the SRS error in a single fiber span for all channels; and
the network component having embedded computer readable code for estimating SRS by observing higher order effects within the DTM.

8. The system according to claim 7, further comprising the network component having embedded computer readable code for extending to estimate the SRS error with both a conventional (C) band detector and an extended (L) band detector of a C&L band system whereby the combined data of the two detectors is inputted into the DTM to estimate the SRS error.
